(19) United States
(12) Patent Application Publication
(10) Pub. No.: US 2018/0338350 A1
(43) Pub. Date: Nov. 22, 2018

(54) CARBON HEATER

(71) Applicant: LG ELECTRONICS INC., Seoul (KR)

(72) Inventor: Youngjun LEE, Seoul (KR)

(21) Appl. No.: 15/978,395

(22) Filed: May 14, 2018

(30) Foreign Application Priority Data
May 19, 2017 (KR) 10-2017-0062251
May 29, 2017 (KR) 10-2017-0066435

(51) Int. Cl. H05B 3/14; H05B 3/03; H05B 3/06; H05B 3/42

(52) U.S. Cl. CPC H05B 3/145; H05B 3/42; H05B 3/06; H05B 3/03

(57) ABSTRACT

A carbon heater is provided that may include a carbon heating element that functions as a heat source; a tube that encloses the carbon heating element; and at least one groove that extends from an outer peripheral portion of the tube in a direction toward a center of the interior of the tube, the carbon heater being capable of preventing a dielectric breakdown, a spark, and plasma therein from occurring, and breakage or destruction of the heat source made of the carbon heating element.

### CROSS-REFERENCE TO RELATED APPLICATION(S)

This application claims priority to and the benefit of Korean Patent Application No. 10-2017-0062251, filed in Korea on May 19, 2017, and Korean Patent Application No. 10-2017-0066435, filed in Korea on May 29, 2017, the disclosures of which are incorporated herein by reference in their entirety.

### BACKGROUND

### 1. Field

A carbon heater having an impact-resistant structure that prevents breakage or destruction of a heat source thereof due to external impact is disclosed herein.

### 2. Background

In recent times, an oven using a heater as a cooking appliance for family use or commercial use has been widely used. FIG. 1 is a perspective view showing a general structure of an oven. Referring to FIG. 1, an oven 1 is provided with a cavity 2 in which food or other items (hereinafter “food”) to be cooked is placed, a door 3 to selectively open and close the cavity 2, and a plurality of heaters 6 to apply heat to the cavity 2. The heater 6 is provided with one or more heating elements, and is protected by a cover 8 from an exterior of the cavity 2.

In order to apply an electromagnetic wave heating method, a magnetron 4 is provided on an upper surface of the cavity 2. The magnetron 4 generates electromagnetic waves, and the generated electromagnetic waves are radiated to an inner space of the cavity 2 through a predetermined waveguide and a stirrer. A sheath heater 5 is provided at an upper side of the inner space of the cavity 2, as necessary.

The heaters are different from each other in terms of an operation depending on a material, and a heating method, for example. Among the heaters, a carbon heater is generally used as the sheath heater 5, and the heater 6 is a grill heater that heats food inside the cavity 2 using a radiant heating method.

For a conventional carbon heater, a carbon fiber (CF) is mainly used. As the CF is made of a material called “carbon”, it has a microwave absorption property of carbon itself.

Further, the CF has an inherent property that a ratio of a fiber length to a fiber diameter is very large in view of properties of a shape of the “fiber”. The inherent properties of such CF cause some problems when the CF is used as a heating source of the oven.

As shown in FIG. 2, the CF is made of individual carbon filaments. However, the filaments have not only a diameter of several micrometers (μm) but also an interval between filaments of several micrometers (μm). Thus, under high electromagnetic fields, a high voltage is applied to a very narrow distance (interval) between the filaments.

For example, when a voltage of 10 V is applied to an interval of 1 μm, a high voltage of about 107 V/m is applied between the filaments. In this case, the filaments are likely to cause a dielectric breakdown, and sometimes a spark occurs.

A conventional carbon heater includes a carbon fiber, a connector to apply electricity to the carbon fiber, a quartz tube including the carbon fiber and the connector therein, and an assembly (or a unit) composed of inert gas, such as Ar, for example. sealed in the tube, The encapsulation gas maintains a vacuum atmosphere of about 10⁻¹ to 10⁻² torr.

However, as described above, when a high voltage is applied between the filaments, plasma is generated due to an inert gas atmosphere under a high voltage, even though a dielectric breakdown or a spark of the filaments does not occur. Conventionally, a shield member was provided between a carbon heater and a cabin to suppress a reaction of the plasma, for example, and a progress of light to the cabin due to the plasma. However, as the shield member not only shields plasma light, but also partially blocks radiation light emitted from the carbon heater, radiation efficiency of the oven is greatly lowered.

Therefore, a new type of carbon heater instead of a conventional fiber-shaped carbon heater is required, and a bulk-shaped carbon heating element may solve problems of the conventional fiber-shaped carbon heater. However, the bulk-shaped carbon heating element has brittleness which is a property inherent in a ceramic material called “carbon”, so it is vulnerable to impact. As such, embodiments disclosed herein provide a heater having an impact-resistant structure for preventing breakage or destruction of the bulk-shaped carbon heating element which is a heat source.

Related art is disclosed in KR Patent Application Publication No. 10-2006-0010083 (Feb. 2, 2006), which is hereby incorporated by reference.

### BRIEF DESCRIPTION OF THE DRAWINGS

Embodiments will be described in detail with reference to the following drawings in which like reference numerals refer to like elements, and wherein:

FIG. 1 is a perspective view showing a general structure of a related electric oven;

FIG. 2 is an enlarged view of a related art carbon fiber;

FIGS. 3A to 7 show various embodiments related to a groove portion or groove in a heater having an impact-resistant structure according to embodiments;

FIGS. 8A-8C shows various shapes of a carbon heating element included in a carbon heater according to embodiments;

FIGS. 9 to 19 show various embodiments related to a connector in a heater having an impact-resistant structure according to embodiments;

FIGS. 20A-20B and 21A-21B show a shape of a carbon heating element included in a carbon heater according to another embodiment;

FIGS. 22 to 29 show other embodiments related to a groove portion or groove in a heater having an impact-resistant structure according to embodiments;

FIG. 30 is a flow chart schematically showing a method for manufacturing a carbon heater using a carbon composite composition according to embodiments;

FIG. 31 is a photograph showing a heating operation state of a carbon heater manufactured using a quaternary carbon composite composition according to embodiments; and

FIG. 32 shows a carbon heater product made of a carbon heating element using a carbon composite composition according to embodiments.

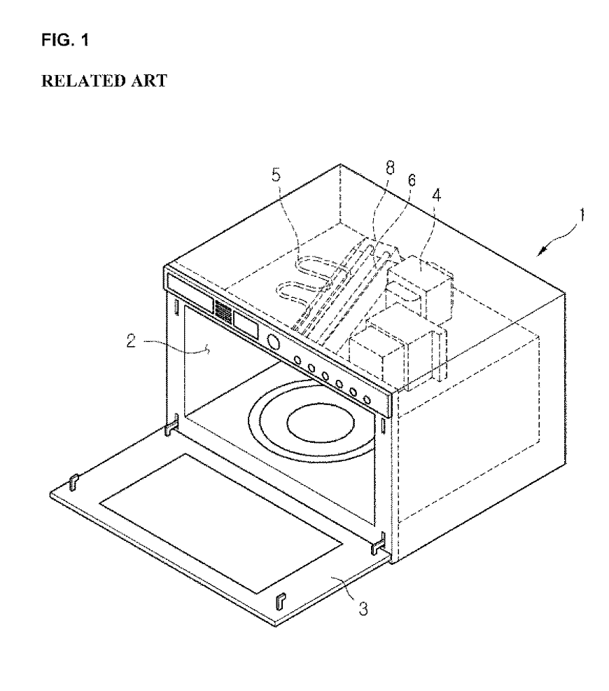

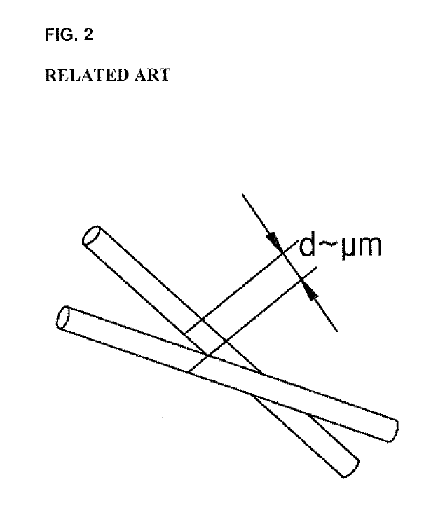

### DETAILED DESCRIPTION

Embodiments are not limited to the embodiments disclosed herein but may be implemented in various different forms. The embodiments are provided to make the description thorough and to fully convey the scope to those skilled in the art. Therefore, the description set forth herein are merely embodiments for the purpose of illustrations only, not intended to limit the scope, so it should be understood that other equivalents and modifications could be made thereto without departing from the spirit and scope.

Hereinafter, a carbon heater according to embodiments will be described with reference to the accompanying drawings. Wherever possible, like reference numerals have been used to indicate like elements, and repetitive disclosure has been omitted.

The carbon heater according to embodiments, which is a heating apparatus using a heating structure (referred to as “carbon heating element”) made of a carbon component, may include various forms of heaters which aim to heat at a predetermined temperature. In the following description, the bulk-shaped carbon heating element is distinguished from a carbon filament which has been used in the conventional carbon heater in terms of concept, and can be understood as a carbon heating element which has a sense of volume to make up for disadvantages of the fiber shape. For example, the bulk-shaped carbon heating element may include a rod-shaped carbon heating element having various shapes of cross-section including a circular cross-section, a tube-shaped carbon heating element having a central aperture, and a tube-shaped carbon heating element having an opening formed in a portion of the tube.

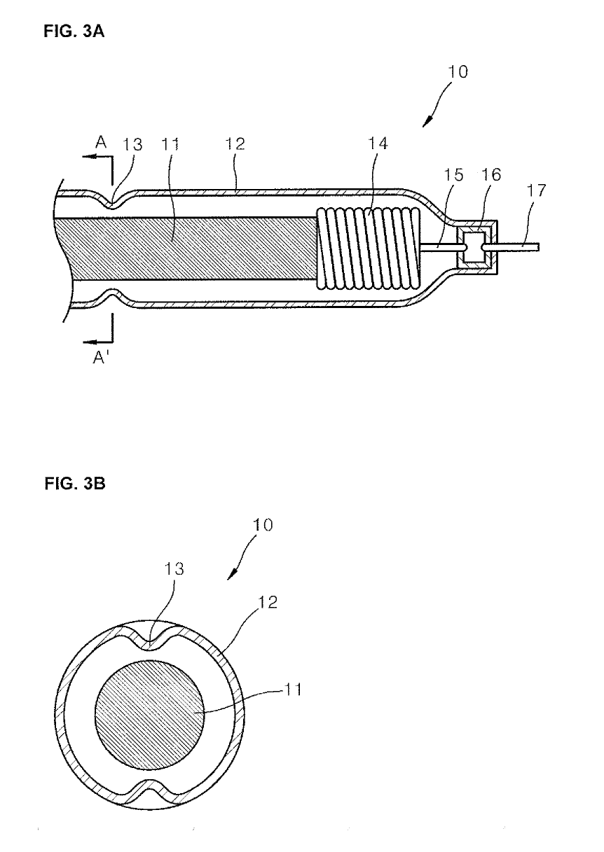

FIGS. 3A-3B shows an embodiment related to a groove portion in a heater having an impact-resistant structure according to embodiments. As shown in FIGS. 3A-3B, a carbon heater 10 may include a carbon heating element 11 as a heat source, a tube 12 that encloses the carbon heating element 11, and a groove portion or groove 13 that extends from an outer peripheral portion of the tube 12 in a direction toward a center of an interior of the tube 12.

The carbon heater may include a connector 14 made of a spring, for example, that elastically applies a tensile force to the carbon heating element 11 which is a heat source, and which is also included in common in a carbon heater using a general carbon fiber as a heat source, and an outer electrode 17 that supplies power to the heat source from outside. The outer electrode 17 may include a metal wire 15 made of a material having excellent electrical conductivity, such as metal, for example, and a metal piece 16 that connects the outer electrode 17 and the metal wire 15; however, embodiments are not limited thereto. Further, the outer electrode 17 itself may supply power to the heat source.

The carbon fiber according to an embodiment may be formed, for example, by sintering a carbon heating element made of a ceramic composition as a heat source. However, materials, such as ceramics, are generally known to have brittleness.

The reason why materials, such as ceramics, are brittle is well explained through Griffith theory of brittle fracture. According to this theory, there are micro cracks in a brittle material, and even when stresses much less than a theoretical cohesive strength is applied to the brittle material, the stresses at a crack tip reach the theoretical cohesive strength, which is a bonding force between atoms of the material, due to stress concentration caused by such cracks, and fracture occurs.

For this reason, the carbon heating element made of the ceramic composition which is a heat source of the heater according to an embodiment inevitably has brittleness. In order to prevent brittle fracture of the carbon heating element, it is necessary to eliminate the micro cracks or reduce the stress or displacement applied to the carbon heating element,

In general, a ceramic material is composed of substances, such as oxide, carbide, and nitrogen, and such substances have a very high melting point due to a strong bonding force between a metal atom and an oxygen, carbon, or nitrogen atom. Thus, it is practically impossible to form a structure with a ceramic material through a method such as melting, and the structure is formed through a sintering method using diffusion which is a phenomenon of transferring mass at a high temperature using a reduction in interfacial energy as a driving force.

However, as such sintering uses ceramic materials in a powder state as a raw material, it is practically impossible to attain a theoretical density of 100% through the sintering. This means that, when a structure is formed through a sintering process using ceramic particles, the structure inevitably has micro grooves or cracks on an interior or surface thereof, and such micro grooves or cracks act as an initiator to brittle fracture. As a result, micro cracks on the interior or the surface of the ceramic material, which are a cause of brittle fracture, inevitably occur.

In a case of a cooking appliance including a carbon heating element, the carbon heating element is conveyed a long distance for a long time before it is assembled to the cooking appliance in an assembly factory. During the conveying process, the carbon heating element is continuously exposed to deformations along with external stresses.

In addition, a heater made of such a carbon heating element has a heat source having an operating temperature exceeding a high temperature of about 1,000° C. or more, even when using for a cooking device. Thermal stresses, thermal impacts, and thermal deformations resulting from a temperature difference between a high operating temperature and a normal temperature promote an environment in which the brittle fracture of the carbon heating element easily occurs. Therefore, in order to prevent the brittle fracture of the ceramic material from occurring, it is necessary to find a method of reducing the stress or displacement applied to the ceramic material because it is practically impossible to remove the cracks.

In order to reduce the stress or displacement applied to a heat source formed of a carbon heating material, which is a type of ceramic material, embodiments disclosed herein may include the groove 13 which extends from an outer periphery of the tube 12 enclosing the carbon heating element 11 in an inner direction of the tube 12. More specifically, the groove 13 according to an embodiment performs a function of preventing vibrations, stress, and deformations which may be applied to the carbon heating element, which is a heat source, thereby preventing breakage of the carbon heating element and prolonging a lifespan of the carbon heater.

The groove 13 may have a shape in which a portion of the tube 12 extends or sinks in an inner direction of the tube 12 up to a depth at which the groove 13 is in contact with the heat source. With such a shape, it is possible to prevent external stress, impacts, or deformations applied to the carbon heating element 11 by preventing movement of the heat source made of the carbon heating element 11.

Further, the groove 13 may not contact the heat source in terms of radiation efficiency and energy efficiency of the carbon heater. Furthermore, destruction of the tube enclosing the carbon heating element may be prevented.

The groove 13 may be present at arbitrary positions in a longitudinal direction of the tube 12 enclosing the carbon heating element 11. This is because the groove portion 13 may prevent external stress, impacts, or deformations applied to the carbon heating element 11 through adjustment of a depth of the groove 13, for example, even though the groove 13 is present anywhere in the longitudinal direction of the tube 12. However, the groove 13 may be positioned near a center or opposite ends of the carbon heating element 11, because such regions are likely to have large stress or displacements to be applied to the carbon heating element 11.

Generally, a carbon heater, which operates at a high temperature, mainly uses a glass tube made of a fused quartz material as the tube enclosing the heat source. The fused quartz tube is glass in which silica (SiO₂) is included in an amorphous form.

Unlike a conventional soda-lime glass, the fused quartz tube is made of an oxide of an alkali earth metal or an alkaline metal, such as sodium, potassium, calcium, or barium, for example, and an oxide, such as lead, or aluminum, for example, so that it does not include a network modifier oxide capable of lowering a melting point and a transition temperature of the glass. When such a network modifier oxide is included in the glass, it lowers the melting point and the transition point of the glass.

Thus, the fused quartz tube, which does not include the network modifier oxide, has a very high operating temperature and melting temperature. As a result, a high purity of the fused quartz tube is a source of excellent optical and thermal properties of the fused quartz tube in comparison to other glass.

When the heat source is heated, heat is directly transferred to the tube by conduction from the heat source, a temperature of the fused quartz tube increases to about 1,650° C. close to a melting point or a softening point, and the fused quartz tube is more likely to be destroyed by devitrification or melting. The term “devitrification” refers to a phenomenon that crystals are precipitated in a glass state.

In general, glass has a thermodynamically unstable amorphous crystal structure. But, at a low temperature, the glass has high viscosity, a small number of crystal nucleation, and a low crystal growth rate, so that the glass may be formed and maintained in a thermodynamically unstable amorphous state. When a temperature of the glass rises, especially at a temperature close to a liquidus temperature, viscosity of the glass is lowered, the number of crystal nucleation increases, and a growth rate of a crystal also increases. Thus, when the temperature rises, a thermodynamically stable crystal is locally formed in amorphous glass.

When a crystalline material is present in the amorphous glass, transparency of the glass disappears and a white crystal grows mainly on the surface. When the transparency of the glass is lost due to surface crystallization caused by the devitrification, a radiation efficiency from the heat source is lowered, resulting in a problem that an efficiency of the carbon heater is lowered. Further, a surface on which the devitrification occurs is mechanically very weak, so easily broken.

That is, when the devitrification occurs, the fused quartz tube is likely to be locally or entirely destroyed. For this reason, the groove according to embodiments may be designed in consideration of an environment in which the carbon heater is used.

More specifically, the groove and the heat source may be designed in a non-contact manner when used at a relatively high operating temperature. On the other hand, when the operating temperature is low, the groove and the heat source may be in contact with each other.

Also, the connector according to embodiments may be made of an elastic body, such as a spring. The connector may prevent stress to the heat source, impact, or deformations when it is structurally designed as an elastic body such as the spring of FIGS. 3A-3B, in addition to performing a function of transferring electricity from an external power source to the heat source.

Also, when the connector is made of the elastic body, it has a more improved function or effect of preventing impact as a result of a synergistic combination of a deformation suppression function of the groove and an impact absorbing function of the connector although the groove does not directly contact the heat source.

As shown in FIGS. 3A-3B, a plurality of the grooves 13 may be formed opposite to each other in a direction toward a center of an interior of the tube 12 at a predetermined position in the longitudinal direction of the tube 12. The structure of the grooves 13 as shown in FIGS. 3A-3B has a synergistic interaction when combined with an arrangement or a configuration of a general carbon heater.

As described above, the carbon heater generally may include the connector 14 and the metal piece 16. The connector 14 may be designed to have a shape of an elastic body, such as a spring, and the metal piece 16 may generally have a thickness thinner than a width thereof.

When stress, impact, or deformations are applied to the carbon heating element 11 from outside, the connector 14 formed of the elastic body may absorb the stress, impact, or deformations. At the same time, the carbon heating element 11 may undergo stress or deformations of its own. However, the metal piece 16 connected to the connector 14 has a lower rigidity in a thickness direction than in a widthwise direction due to a characteristic of a shape thereof, and thus, the actual carbon heating element 11 is mainly deformed or deformably moved in a thickness direction of the metal piece 16.

Thus, when the grooves 13 of FIGS. 3A-3B are vertically arranged in the thickness direction of the metal piece 16, there is an advantage that it is possible to prevent stress, impacts, or deformations applied to the carbon heating element 11 in substantially all directions, solely with two discontinuous grooves 13. When the grooves 13 of FIG. 3A-3B are in contact with the heat source which is the carbon heating element 11, the carbon heater 10 has a synergistic function or effect of preventing stress, impacts, or deformations applied in all directions, merely by forming the two discontinuous grooves opposite to each other in a direction toward the center of the interior of the tube 12.

The grooves 13 according to embodiments may be formed at a position enclosing the connector 14 in the longitudinal direction of the tube 12. As described above, even though the tube enclosing the heat source in the carbon heater is made of a material usable at a high temperature, such as fused quartz, heat transfer from the heat source to the tube by conduction resulting from physical contact between the heat source and the tube may be avoided.

A carbon heater having a general structure essentially may include the connector 14 as shown in FIGS. 3A-3B, and the connector 14 may generally be formed of a refractory metal, which maintains strength at a relatively high temperature, such as nickel (Ni) or molybdenum (Mo). This metal has a very low specific resistance in comparison to carbon, and thus, in the carbon heater using an electromagnetic wave heating method, the connector may be maintained at a significantly lower temperature than the heat source made of the carbon heating element. Hence, when the groove extending from an outer surface of the tube in the direction toward the center of the interior of the tube is formed at a position enclosing the connector made of the metal material in the carbon heater having an impact-resistant structure according to embodiments, the groove may be maintained at a relatively low temperature, thereby preventing a reduction in transmittance and efficiency of the carbon heater and destruction of the tube resulting from the devitrification.

A method of forming the groove according to embodiments may be easily and repeatedly implemented through a conventional glass processing method. This method is widely known to those skilled in the art.

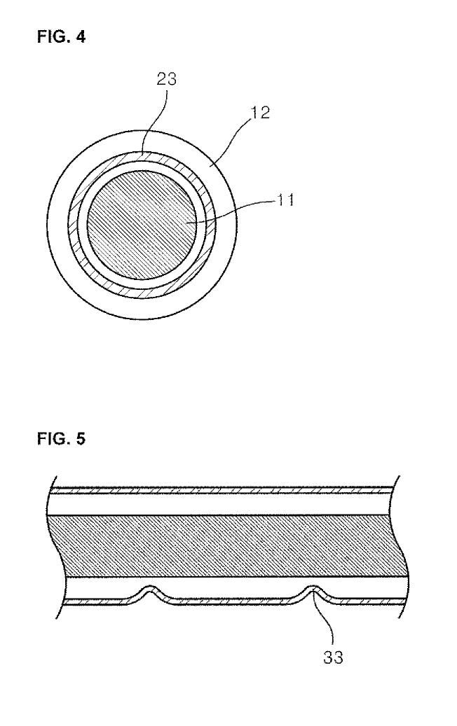

According to another embodiment, a groove portion or groove 23 may have a shape continuously extending from a predetermined position in the longitudinal direction of the tube in the direction toward the center of the interior of the tube, as shown in FIG. 4. The carbon heater is subjected to a long distance and/or a long time transfer process before the carbon heater is assembled into a final product, such as a cooking appliance. During the transfer process, the carbon heater, especially the carbon heating element which is a heat source, receives stress, impacts, or deformations applied in various sizes and directions from outside. When the groove 23 has a shape continuously extending in the direction toward the center of the tube 12, the brittle carbon heating element may absorb the stress, impacts, or deformations applied in all directions by means of the groove 23, thereby preventing lifespan shortening and destruction of the carbon heater.

FIG. 5 shows another embodiment related to the groove in a heater having an impact-resistant structure according to embodiments. As shown in FIG. 5, two or more groove portions or groove 33 according to embodiments may be spaced apart from each other in the longitudinal direction of the tube.

Once the carbon heater has been generally assembled into a cooking appliance, for example, stress, impacts, or deformations applied to the carbon heater may be mainly classified into stress and thermal stress resulting from its own weight, or thermal impact. One of the most frequent and largest stresses or deformations is stress and deformation resulting from its own weight. Hence, when the two or more grooves 33 spaced apart from each other in the longitudinal direction of the tube 12 are formed toward the center of the tube 12 from an opposite direction of gravity, the stress or deformations resulting from a weight of the carbon heating element may be greatly reduced.

However, even though the grooves 33 may be arranged as shown in FIG. 5, it is not possible to absorb stress, impacts, or deformations in all directions which may occur during the transfer process of the carbon heating element 11. However, it is possible to absorb stress, impacts, or deformations applied in at least one direction or in multiple directions (when the grooves extend in different directions), and thus, the groove may make a considerable contribution to lifespan prolongation and destruction prevention of the carbon heater.

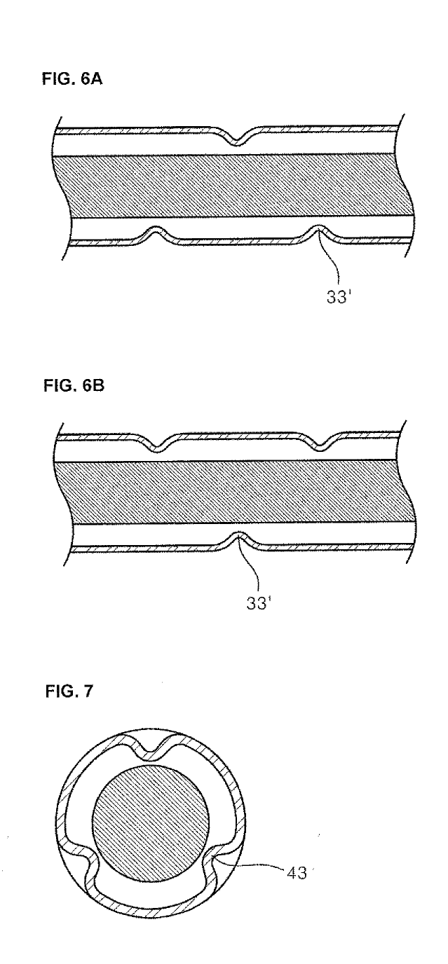

FIGS. 6A-6B show one of modification of the embodiment or FIG. 5, that is, FIGS. 6A-6B show another embodiment, in which one or two of at least three groove portions or grooves 33′ is/are arranged in an opposite direction of the gravity applied to the carbon heating element and the remaining grooves is/are arranged in a gravity direction.

The grooves 33′ arranged as shown in FIGS. 6A-6B may prevent stress or deformations applied in a vertical direction in comparison to the grooves 33 arranged as shown in FIG. 5. In particular, when the grooves 33′ of FIGS. 6A-6B are in contact with the heat source which is a carbon heating element, the carbon heater has a synergistic function or effect of preventing stress, impacts, or deformations applied not only in a vertical direction but also in substantially all directions even though the grooves are not formed in a continuous shape.

FIG. 7 shows another embodiment related to the grooves in a heater having an impact-resistant structure according to embodiments. As shown in FIG. 7, a plurality of groove portions or grooves 43 may be formed at an angle of 120 degrees or less with respect to each other in the direction toward the center of the interior of the tube 12 from the outer periphery of the tube 12 at a predetermined position in the longitudinal direction of the tube 12.

The carbon heater having a structure shown in FIG. 7 has a synergistic function or effect of preventing stress, impacts, or deformations applied in all directions merely by adjusting a diameter of the carbon heating element, a diameter of the tube and an angle (distance) between the plurality of grooves, irrespective of whether or not there are other components of the carbon heater, or a coupling relationship between the groove and the other components. More specifically, when the plurality of grooves is arranged so that a shortest distance between the grooves is shorter than a diameter of the carbon heating element, the grooves may prevent deformation of the carbon heating element against stress, impacts, or deformations applied in all directions, as shown in FIG. 7. As a result, it is possible to make a considerable contribution to lifespan prolongation and destruction prevention of the carbon heater.

When compared to embodiments having existing other discontinuous grooves, the grooves 43 arranged as shown in FIG. 7 do not need to be in contact with the carbon heating element. Thus, it is more effective in preventing the tube from being devitrified, so that it is advantageous for improving efficiency of the carbon heater and preventing destruction of the carbon heater. Also, when compared to embodiments having existing continuous grooves, the grooves 43 arranged as shown in FIG. 7 have a reduced area or volume, so that it is advantageous in terms of a yield decline resulting from cracks, for example, which may occur when forming grooves, and radiation efficiency.

Various embodiments related to the connector in a heater having an impact-resistant structure according to embodiments will be described hereinafter.

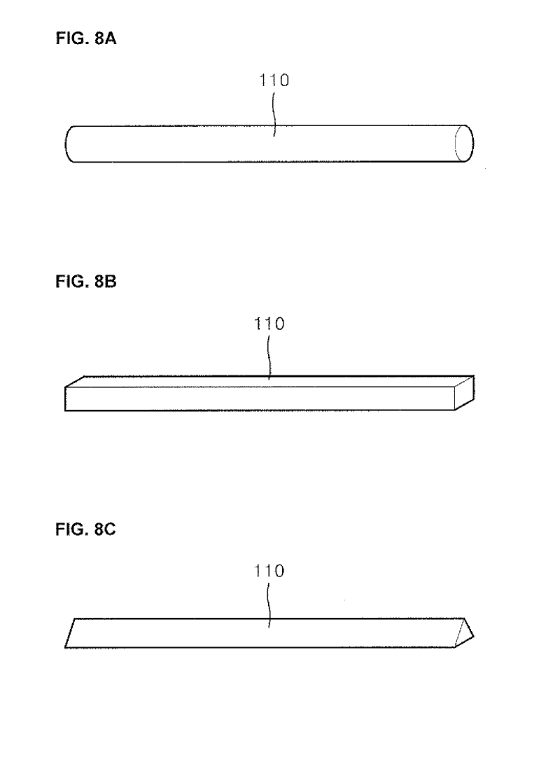

Hereinafter, a carbon heater 100 according to an embodiment of the connector will be described with reference to FIGS. 8A to 12.

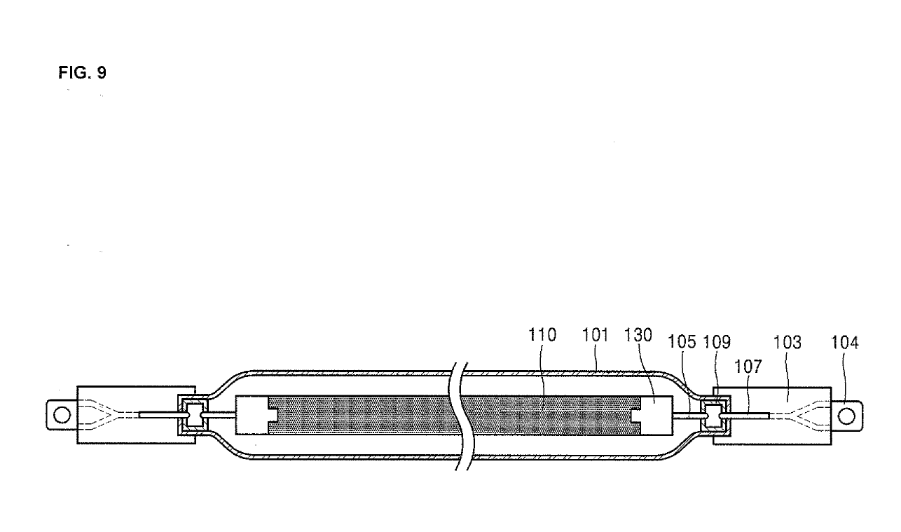

FIGS. 8A-8C shows various shapes of a carbon heating element included in a carbon heater according to an embodiment of the connector in a heater having an impact-resistant structure according to embodiments. More specifically, FIGS. 8A-8C show various shapes of a carbon heating element 110 having a bulk shape included in a carbon heater 100 (refer to FIGS. 9 to 19) according to an embodiment.

A rod-shaped carbon heating element 110 having a circular cross-sectional shape or a polygonal cross-sectional shape including a square, or a triangle, for example, may be used for the carbon heater 100 (refer to FIGS. 9 to 19) according to an embodiment of the connector in the heater having an impact-resistant. As specific examples, FIG. 8A shows the rod-shaped carbon heating element 110 having a circular cross-section, and FIGS. 8B and 8C show the rod-shaped carbon heating element 110 having a rectangular cross-section and the rod-shaped carbon heating element 110 having a triangular cross-section, respectively. Although not shown in the drawings, the polygonal cross-section may further include various cross-sectional shapes, such as a pentagonal cross-section, or a hexagonal cross-section, for example, and embodiments are not limited to the illustrated cross-sectional shapes.

FIGS. 9 to 19 schematically show an internal structure of a carbon heater according to an embodiment of a connector in a heater having an impact-resistant structure according to embodiments. Carbon heaters illustrated in FIGS. 9 to 19 may have the same or similar components except for a coupling structure between the carbon heating element 110 and connectors 130, 140, 150 and 160. Hence, the carbon heater will be described with reference to respective drawings, focusing on the coupling structure of the carbon heating element 110 and the connectors 130, 140, 150 and 160.

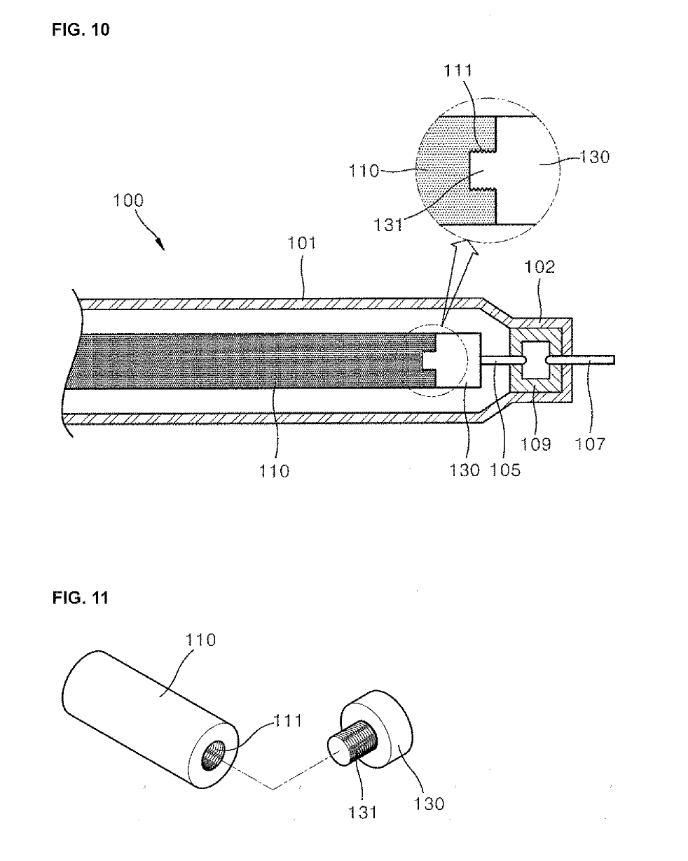

Referring to FIGS. 9 and 10, the illustrated carbon heater 100 may include a tube 101, a carbon heating element 110, and connectors 130. The tube 101 may be configured such that an interior thereof is sealed through a sealing portion or seal 102 formed at each of opposite ends thereof in a state of the interior thereof being filled with vacuum or inert gas.

The tube 101 may made of a quartz material; however, embodiments are not limited thereto. For the tube 101, any tube-shaped member having a sufficient heat resistance and strength, such as a special glass tube, may be used.

The carbon heating element 110 may be arranged in parallel with the tube 101 in a longitudinal direction of the tube 101 within the tube 101.

As shown in FIGS. 8A-8B, the rod-shaped carbon heating element 110 may be provided in various cross-sectional shapes, such as a circular cross-section (refer to of FIG. 8A), a rectangular cross-section (refer to FIG. 8b), or a triangular cross-section (refer to FIG. 8C), for example. In the following description, the rod-shaped carbon heating element 110 having a circular cross-section will be described as an example.

The connectors 130 may be coupled to opposite ends of the carbon heating element 110, respectively. The connectors 130 coupled to the opposite ends of the carbon heating element 110 may solve problems occurring when using a conventional carbon fiber and protect the carbon heating element 110 from external impact.

In particular, the rod-shaped carbon heating element 110 provided in a bulk shape has a brittleness which is a property inherent in a ceramic material, so it is vulnerable to impact. In order to enhance durability of the carbon heating element 110, a pair of connectors 130 may be coupled to the opposite ends of the carbon heating element 110, respectively.

Outer electrodes 107 may be provided to protrude outward from the sealing portions 102 constituting the opposite ends of the tube 101, respectively. The opposite ends of the carbon heating element 110, which is arranged in a longitudinal direction of the tube 101 within the tube 101, may be coupled to the connectors 130, respectively.

The connectors 130 coupled to the opposite ends of the carbon heating element 110 may be electrically connected to metal wires 105, respectively. The metal wires 105 may be electrically connected to the outer electrodes 107 through metal piece 109 respectively fixed to the sealing portions 102, respectively.

FIG. 9 shows an overall shape of the carbon heater 100. The outer electrodes 107 may be enclosed by outer connectors 103, respectively, and may be electrically connected to outer terminals 104 that respectively protrude outward from the outer connector 103, respectively.

Hereinafter, a coupling structure between the carbon heating element 110 and the connectors 130 shown in FIG. 10 will be described.

The carbon heating element 110 may be arranged in the longitudinal direction of the tube 101 within the tube 101, The connectors 130 may be coupled to the opposite ends of the carbon heating element 110 to fix the carbon heating element 110, respectively.

As a specific example, each of the connectors 130 may be provided with a screw protrusion 131, and each of the opposite ends of the carbon heating element 110 may be provided with a screw groove 111. The respective screw protrusions 131 provided on the connectors 130 may protrude toward a center of the cross-section of the carbon heating element 110 by a predetermined length, and a screw thread may be formed on protruded outer peripheral surfaces. The respective screw grooves 111 provided at the opposite ends of the carbon heating element 110 may have a size and a shape corresponding to a size and shape of the respective screw protrusion 131 such that the screw grooves 111 may be respectively engaged with the screw protrusions 131.

Referring to FIG. 10, the respective connectors 130 may have a same diameter as the carbon heating element 110; however, embodiments are not limited thereto. Thus, the respective connectors 130 may have a larger diameter than the carbon heating element 110.

FIG. 11 shows a screw coupling structure between the carbon heating element 110 and the connectors 130 in three dimensions, that is, specifically shows a structure in which the screw protrusion 131 of one of the connectors 130 is coupled to the screw groove 111 of one end of the carbon heating element 110. As the carbon heating element 110 and the connectors 130 are screw-coupled in this manner, they have an increased mutual contact area, thereby mitigating impact.

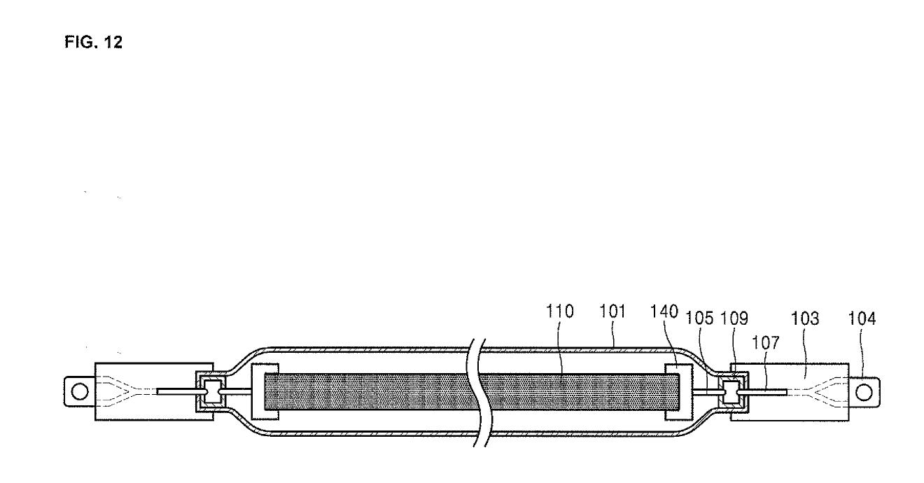

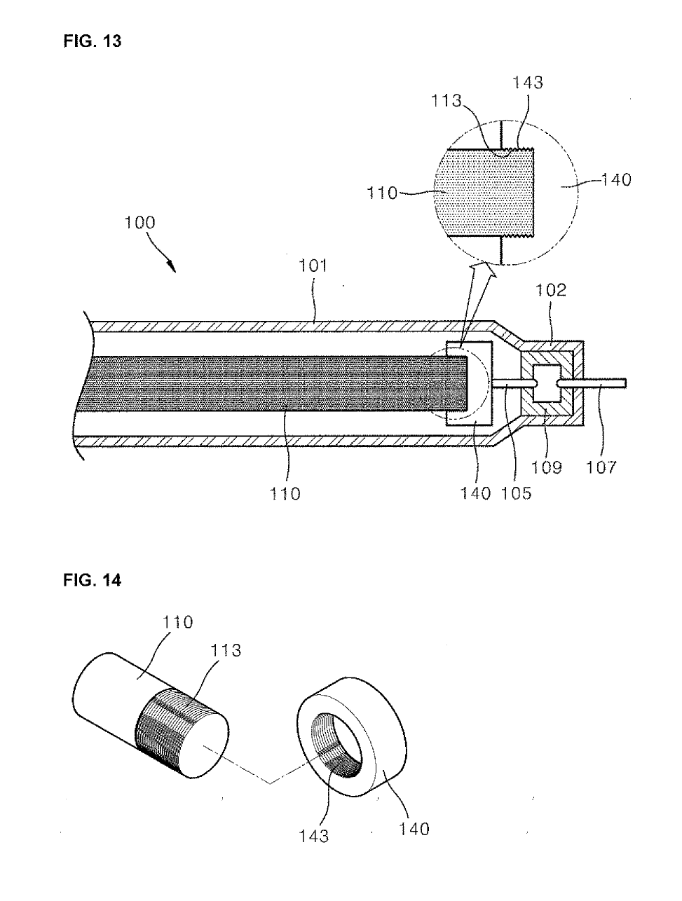

FIG. 12 shows an overall shape of carbon heater 100. FIG. 13 is an enlarged view of a coupling portion between the carbon heating element 110 and one of connectors 140 in the carbon heater 100 shown in FIG. 12.

In FIGS. 12 and 13, the illustrated carbon heater 100 may include the tube 101, the carbon heating element 110, and the connectors 140. The connectors 140 respectively coupled to the opposite ends of the carbon heating element 110 may be electrically connected to the metal wires 105, respectively. The metal wires 105 may be electrically connected to the outer electrodes 107 through the metal pieces 109 respectively fixed to the sealing portions 102, respectively. The outer electrodes 107 may be enclosed by the outer connectors 103, respectively, and may be electrically connected to the outer terminals 104 respectively protruding outward from the outer connectors 103, respectively.

Hereinafter, a coupling structure between the carbon heating element 110 and the connectors 140 shown in FIG. 13 will be described.

The carbon heating element 110 may be arranged in the longitudinal direction of the tube 101 within the tube 101. The connectors 140 may be coupled to the opposite ends of the carbon heating element 110 to fix the carbon heating element 110, respectively.

As a specific example, each of the connectors 140 shown in FIG.13 may be provided with a screw groove 143, and each of the opposite ends of the carbon heating element 110 may be provided with a screw protrusion 113. The screw protrusions 113 provided at the opposite ends of the carbon heating element 110 respectively may protrude toward the screw grooves 143 formed on the connectors 140 by a predetermined length, and screw threads may be formed on a protruded outer peripheral surface, respectively.

The respective grooves 143 of the connectors 140 may have a size and a shape corresponding to a size and a shape of the respective screw protrusions 113 provided at the opposite ends of the carbon heating element 110 such that the screw grooves 111 may be respectively engaged with the screw protrusions 131. The connectors 140 are shown to have a relatively larger diameter than the carbon heating element 110; however, embodiments are not limited the illustrated shape.

FIG. 14 shows a screw coupling structure between the carbon heating element 110 and the connectors 140 in three dimensions, that is, specifically shows a structure in which the screw protrusion 113 of one end of the carbon heating element 110 is coupled to the screw groove 11 of one of the connectors 140. As the carbon heating element 110 and the connector 140 are screw-coupled in this manner, they have an increased mutual contact area, thereby mitigating impact.

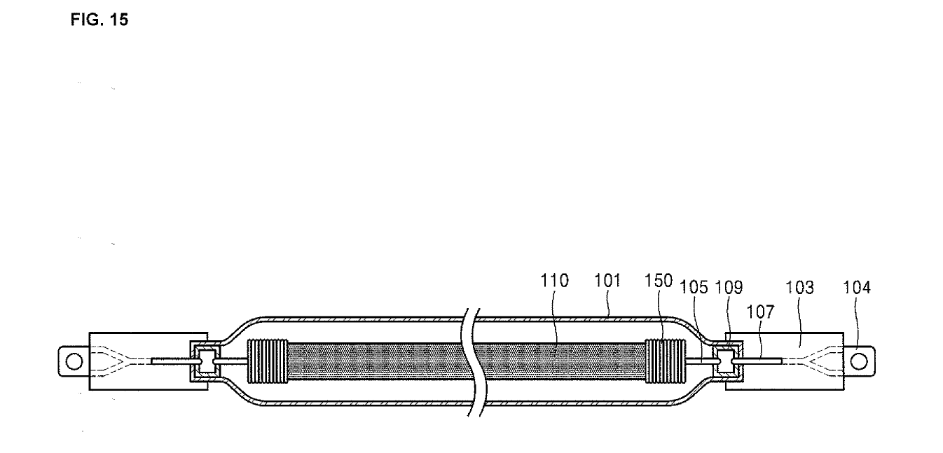

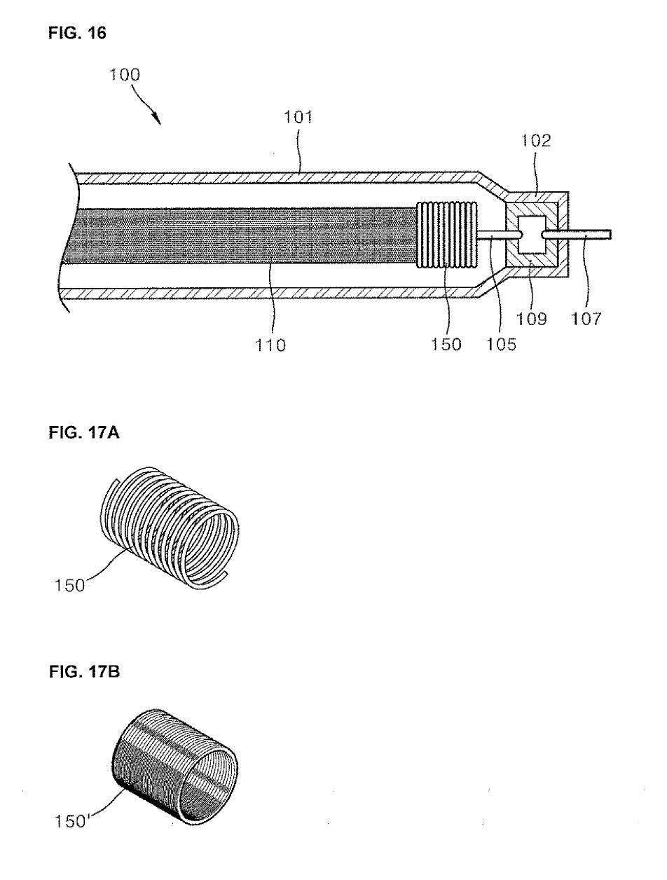

FIG. 15 shows an overall shape of carbon heater 100. FIG. 16 is an enlarged view of a coupling portion between the carbon heating element 110 and one of connectors 150 in the carbon heater 100 shown in FIG. 15.

Referring to FIGS. 15 and 16, the illustrated carbon heater 100 may include the tube 101, the carbon heating element 110, and the connectors 150. The connectors 150 respectively coupled to the opposite ends of the carbon heating element 110 may have a coil spring shape, and may be electrically connected to the metal wires 105, respectively. The metal wires 105 may be electrically connected to the outer electrodes 107 through the metal pieces 109 respectively fixed to the sealing portions 102, respectively.

The outer electrodes 107 may be enclosed by the outer connectors 103, respectively, and may be electrically connected to the outer terminals 104 respectively protruding outward from the outer connectors 103, respectively.

Hereinafter, a coupling structure between the carbon heating element 110 and the connectors 150 shown in FIG. 16 will be described.

The carbon heating element 110 may be arranged in the longitudinal direction of the tube 101 within the tube 101. The connectors 150 may be coupled to the opposite ends of the carbon heating element 110 to fix the carbon heating element 110, respectively.

As a specific example, the connectors 150 shown in FIG.16 may have a coil spring shape. For example, the coil spring-shaped connectors may be made of a metal having a predetermined elasticity, so that the connectors 150 may be elastically expanded and contacted, and may be coupled to the carbon heating element 110 in such a manner as to wrap around the opposite ends of the carbon heating element 110, respectively. As such, it is possible to maintain an arrangement of the carbon heating element 110, and to strengthen the impact resistance so that the carbon heating element 110 is not damaged or destroyed by external impact.

FIGS. 17A-17B shows an exemplary shape of the abovementioned connectors 150 in three dimensions. FIG. 17A shows a coil spring-shaped connector 150, and FIG. 17B shows a connector 150′ according to a modified example in which screw threads are formed on at least one of an outer peripheral surface and an inner peripheral surface thereof.

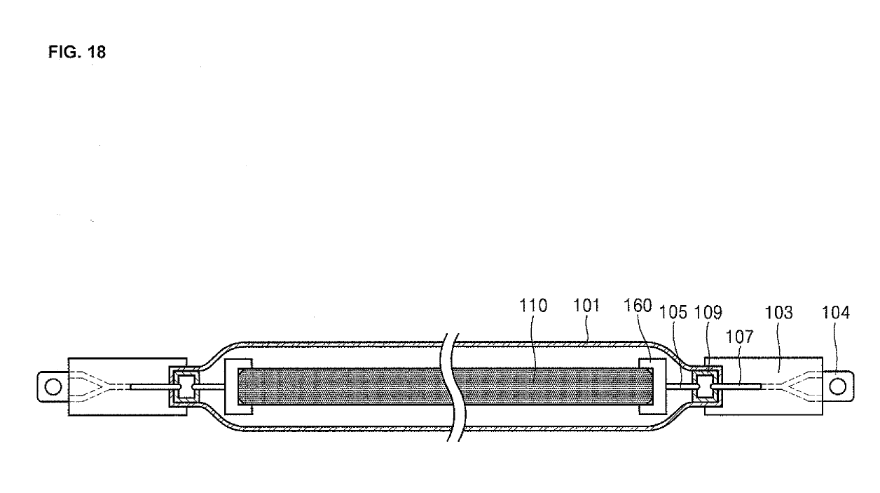

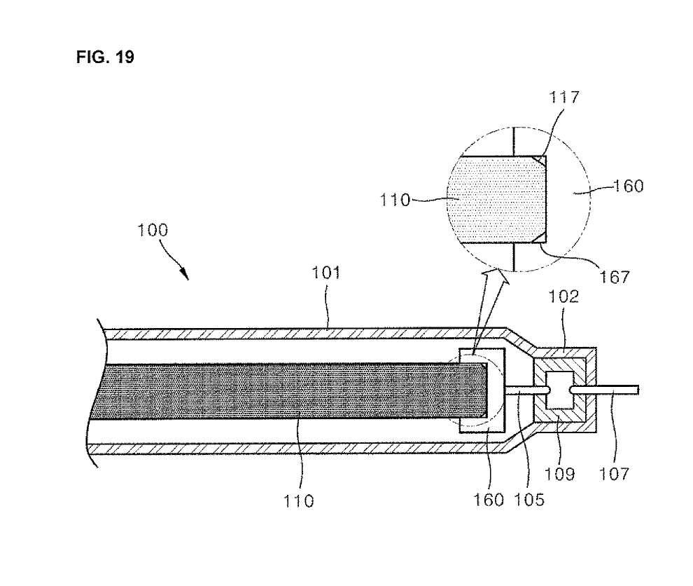

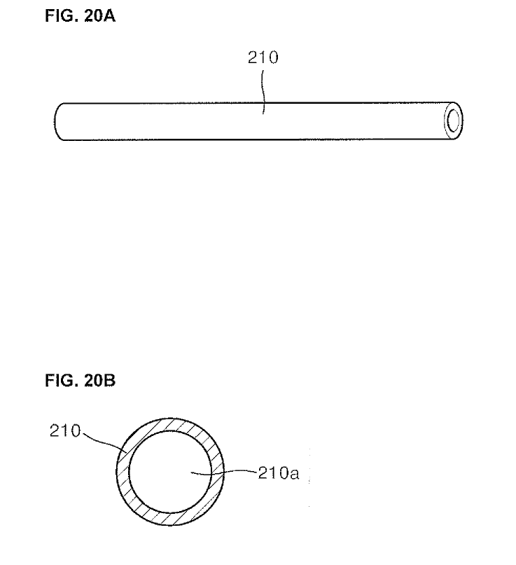

FIG. 18 shows an overall shape of carbon heater 100. FIG. 19 is an enlarged view of a coupling portion between the carbon heating element 110 and one of connectors 160 in the carbon heater 100 shown in FIG. 18.

Referring to FIGS. 18 and 19, the illustrated carbon heater 100 may include the tube 101, the carbon heating element 110, and the connectors 160. The connectors 160 respectively coupled to the opposite ends of the carbon heating element 110 may be electrically connected to the metal wires 105, respectively. The metal wires 105 may be electrically connected to the outer electrodes 107 through the metal pieces 109 respectively fixed to the sealing portions 102, respectively. The outer electrodes 107 may be enclosed by the outer connectors 103, respectively, and may be electrically connected to the outer terminals 104 respectively protruding outward from the outer connectors 103, respectively.

The carbon heating element 110 may be arranged in the longitudinal direction of the tube 101 within the tube 101, The connector 160 may be coupled to the opposite ends of the carbon heating element 110 to fix the carbon heating element 110, respectively.

As a specific example, each of the connectors 160 shown in FIG.18 may be provided with an insertion groove 167, and the insertion groove 167 may differ from the screw groove 143 of each of the connectors 140 shown in FIG. 13 in that no screw thread is provided. That is, an interior of the insertion groove 167 may be formed smoothly.

The opposite ends of the carbon heating element 110 may be inserted and coupled into the insertion grooves 167 of the connectors 160 in a fitting manner, respectively. For smooth insertion, chamfered portions 117 may be formed at the opposite ends of the carbon heating element 110, respectively. Shapes of the chamfered portions 117 may be different from the illustrated shapes, and may be various shapes.

In addition, although not shown in the drawings, an adhesive may be applied between the respective insertion grooves 167 of the connectors 160 and the opposite respective ends of the carbon heating element 110 inserted into the insertion grooves 167. For example, when a high-temperature adhesive is applied, an interlocking strength between the respective connectors 160 and the opposite respective ends of the carbon heating element 110 may be further enhanced.

A carbon heater 200 according to another embodiment of a connector in a heater having an impact-resistant structure according to embodiments will be described with reference to FIGS. 20A to 29.

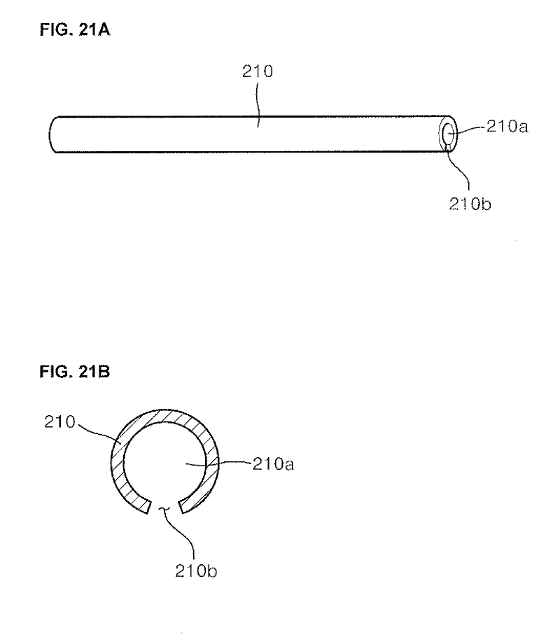

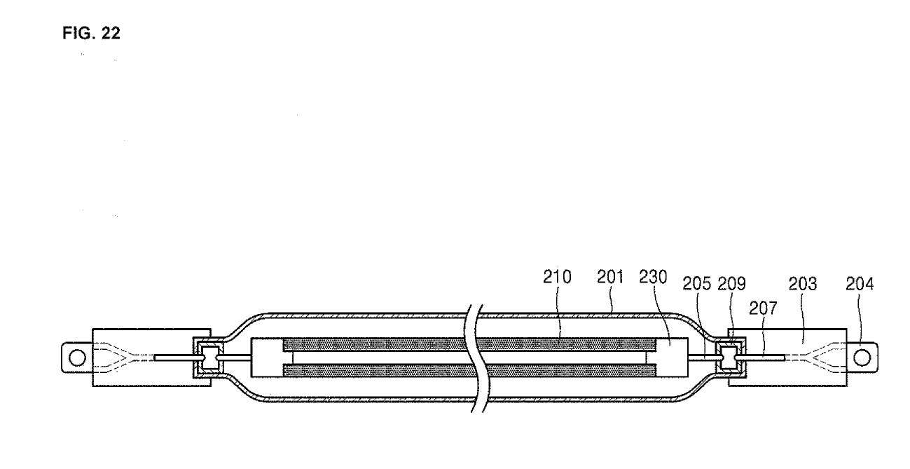

FIGS. 20A-20B and 21A-21B each show a shape of the carbon heating element included in a carbon heater according to another embodiment of a connector in a heater having an impact-resistant structure according to embodiments. More specifically, FIGS. 20A-20B shows one exemplary shape of a carbon heating element 210 having a bulk shape included in the carbon heater 200 (refer to FIGS. 22 to 29) according to another embodiment of a connector in a heater having an impact-resistant structure.

That is, the carbon heating element 210 shown in FIGS. 20A-20B may be formed in a tube shape having a central aperture 210a. A size of the central aperture 210a or a ratio of the central aperture 210a to an entire cross-sectional area of the carbon heating element 210 may be changed in various ways, and is not limited to the illustrated shape.

FIGS. 21A-21B show another exemplary shape of the bulk-shaped carbon heating element 210 included in the carbon heater 200 (refer to FIGS. 22 to 29) according to another embodiment. The carbon heating element 210 shown in FIGS. 21A-21B is formed in a tube shape having the central aperture 210a. Unlike the carbon heating element 210 shown in FIGS. 20A-20B, the carbon heating element 210 of FIGS. 21A-21B has a shape in which a portion of the tube is cut such that a circular arc is provided with an opening 210b.

The carbon heating elements 210 shown in FIGS. 20A-20B and 21A-21B are different from each other in terms of whether or not there is the opening 210b, but are similar to each other in that both have the central aperture 210a. The carbon heating elements 210 shown in FIGS. 20A-20B and 21A-21B will be described with reference to FIGS. 22 to 29.

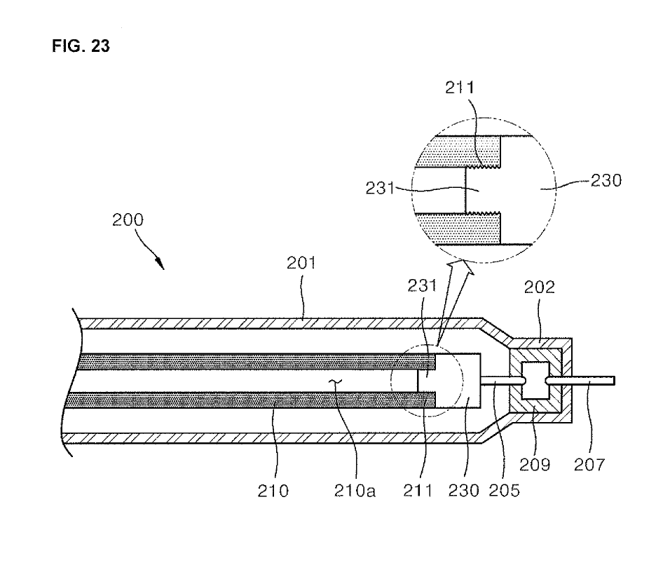

FIGS. 22 to 29 schematically show an internal structure of a carbon heater according to another embodiment. FIG. 22 shows an overall shape of the carbon heater 200. FIG. 23 is an enlarged view of a coupling portion between the carbon heating element 210 and one of connectors 230 in the carbon heater 200 shown in FIG. 22.

Referring to FIGS. 22 and 23, the illustrated carbon heater 200 may include tube 201, carbon heating element 210, and connectors 230. The tube 201 may be configured such that an interior thereof is sealed through sealing portion or seal 202 formed at each of the opposite ends thereof in a state of the interior thereof being filled with vacuum or inert gas.

The tube 201 may be made of a quartz material; however, embodiments are not limited thereto. For the tube 201, any tube-shaped member having a sufficient heat resistance and strength, such as a special glass tube, may be used.

The carbon heating element 210 may be arranged in a longitudinal direction of the tube 201 within the tube 201. The carbon heating element 210 may be formed in a tube shape having the central aperture 210a as shown in FIGS. 20A-20B, or in a tube shape in which a portion of the tube is cut such that a circular arc is provided with an opening 210b, as shown FIGS. 21A-21B.

The connectors 230 may be coupled to the opposite ends of the carbon heating element 210, respectively. More specifically, the connectors 230 may be respectively coupled to the opposite ends of the carbon heating element 210 to protect the carbon heating element 210 from external impact.

In particular, the carbon heating element 210 has brittleness which is a property inherent in a ceramic material because it does not use a carbon fiber and has a bulk shape, that is, a tube shape having a central aperture, so that it is vulnerable to impact. For this reason, the illustrated connectors 230 may be respectively coupled to the opposite ends of the carbon heating element 210 to prevent breakage or destruction of the carbon heating element 210 and enhance durability of the carbon heating element 210.

Outer electrodes 207 may be provided to respectively protrude outward from the sealing portions 202 constituting the opposite ends of the tube 201, and the opposite ends of the carbon heating element 210 may be respectively coupled to the connectors 230 within the tube 201.

The connectors 230 respectively coupled to the opposite ends of the carbon heating element 210 may be electrically connected to metal wires 205, respectively, and the metal wires 205 may be electrically connected to the outer electrodes 207 through metal pieces 209 respectively fixed to the sealing portion 202, respectively. The outer electrodes 207 may be enclosed by the outer connectors 203, respectively, and may be electrically connected to outer terminals 204 respectively protruding outward from the outer connectors 203, respectively.

A coupling structure between the carbon heating element 210 and the connectors 230 will be described with reference to FIG. 23.

The carbon heating element 210 may be arranged in the longitudinal direction of the tube 201 within the tube 201, and the connectors 230 may be coupled to the opposite ends of the carbon heating element 210, respectively. FIG. 23 shows only one end of the carbon heating element 210, and a structure in which one of connectors 230 is coupled to one end of the carbon heating element 210. A structure in which the other end of the carbon heating element 210 is coupled to the other connector is omitted as the structure is configured in the same manner as the one end shown in FIG. 22.

As a specific example, each of the connectors 230 may provided with a screw protrusion 231. Each of the opposite ends of the carbon heating element 210 formed in a tube shape having a central aperture 210a along the center of the cross-section thereof is provided with a screw thread (for example, a female screw thread) 211 through an inner peripheral surface of the central aperture 210a. As such, the screw protrusions 231 provided on the connectors 230 may be screw-coupled to the screw threads 211 provided at the opposite ends of the carbon heating element 210 through an inner peripheral surface of the central aperture 210a, respectively.

The respective connectors 230 are shown to have a same diameter as the carbon heating element 210; however, embodiments are not limited thereto. Thus, the respective connectors 230 may be have a larger diameter than the carbon heating element 110.

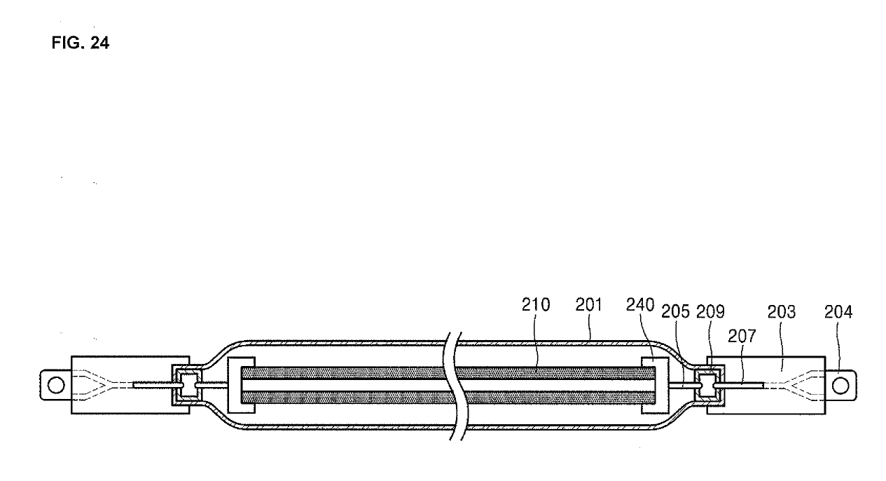

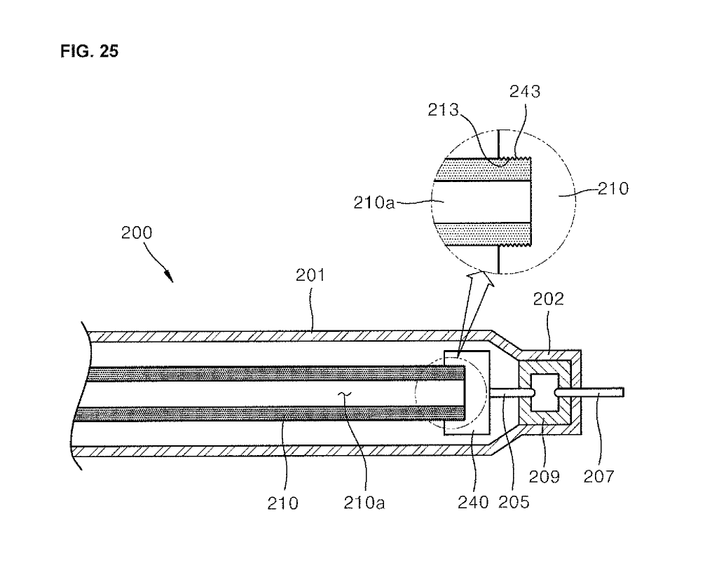

FIG. 24 shows an overall shape of carbon heater 200. FIG. 25 is an enlarged view of a coupling portion between the carbon heating element 210 and one of connectors 240 in the carbon heater 200 shown in FIG. 24.

Referring to FIGS. 24 and 25, the illustrated carbon heater 200 may include the tube 201, the carbon heating element 210, and connectors 240. The connectors 240 respectively coupled to the opposite ends of the carbon heating element 210 may have a coil spring shape, and may be electrically connected to the metal wires 105. The metal wires 205 may be electrically connected to the outer electrodes 207 through the metal pieces 209 respectively fixed to the sealing portions 202, respectively. The outer electrodes 207 may be enclosed by the outer connectors 203, respectively, and may be electrically connected to the outer terminals 204 respectively protruding outward from the outer connectors 203, respectively.

Referring to FIG. 25, the carbon heating element 210 may be arranged in the longitudinal direction of the tube 201 within the tube 201, and the connectors 240 may be coupled to the opposite ends of the carbon heating element 210, respectively. Each of the connectors 240 may be provided with a screw groove 243, and a screw thread 213 corresponding to the screw groove 243 may be formed on an outer peripheral surface of each of the opposite ends of the carbon heating element 210.

By means of such a structure, the opposite ends of the carbon heating element 210 may be screw-coupled to the screw grooves 243 of the connectors 240, respectively. That is, each of the opposite ends of the carbon heating element 210 formed in a tube shape having the central aperture 210a along the center of the cross-section thereof may be provided with a screw thread (for example, a male screw thread) 213 through the inner peripheral surface of the central aperture 210a, and thus, the screw grooves 243 of the connectors 240 may be screw-coupled to the opposite ends of the carbon heating element 210, respectively. In addition, although not shown in the drawings, the screw grooves 243 of the connectors 240 may be respectively screw-coupled to separate screw protrusions (not shown) protruding by a predetermined length through the opposite ends of the carbon heating element 110.

The respectively connectors 240 are shown to have a relatively larger diameter than the carbon heating element 210; however, embodiments are not limited thereto. That is, the connectors 240 may have various sizes.

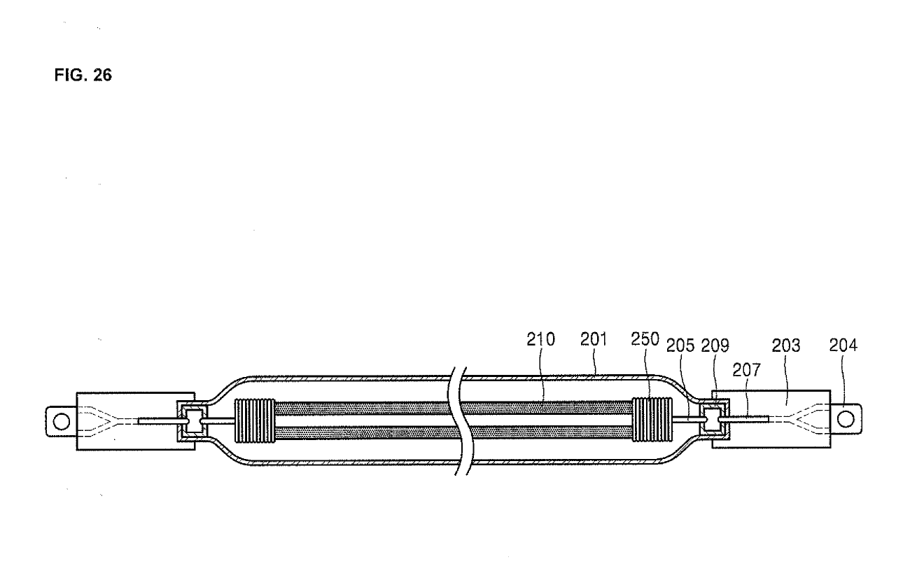

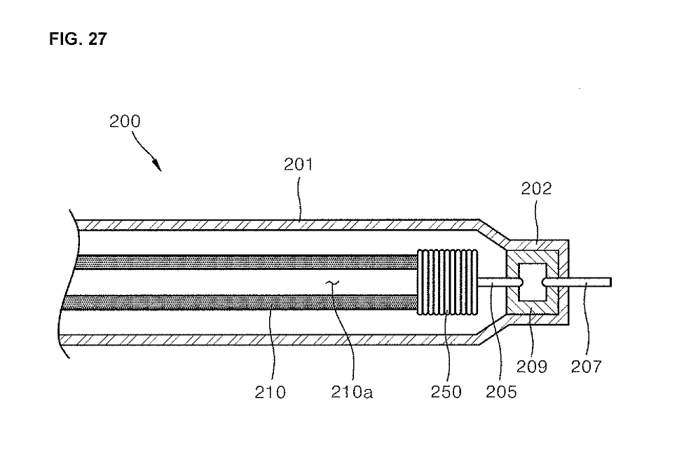

FIG. 26 shows an overall shape of carbon heater 200. FIG. 27 is an enlarged view of a coupling portion between the carbon heating element 210 and one of connectors 250 in the carbon heater 200 shown in FIG. 26.

Referring to FIGS. 26 and 27, the illustrated carbon heater 200 may include the tube 201, the carbon heating element 210, and connectors 250. The connectors 250 respectively coupled to the opposite ends of the carbon heating element 210 may be electrically connected to the metal wires 205, respectively, and the metal wires 205 may be electrically connected to the outer electrodes 207 through the metal pieces 209 respectively fixed to the sealing portions 202, respectively. The outer electrodes 207 may be enclosed by the outer connectors 203, respectively, and may be electrically connected to the outer terminals 204 respectively protruding outward from the outer connectors 203, respectively.

Referring to FIG. 27, the carbon heating element 210 may be arranged in the longitudinal direction of the tube 201 within the tube 201, and the connectors 250 may be coupled to the opposite ends of the carbon heating element 210, respectively.

As a specific example, the connectors 250 may have a coil spring shape. The coil spring-shaped connectors 250 may be made of a metal having a predetermined elasticity, so that the connectors 250 may be elastically expanded and contacted, and may be coupled to the carbon heating element 210 in such a manner as to wrap around the opposite ends of the carbon heating element 210. As a result of the connectors 250 being coupled to the carbon heating element 210 in this manner, it is possible to strengthen the impact resistance so that the carbon heating element 210 is not a damaged or destroyed by external impact.

Although not shown in the drawings, the coil spring-shaped connectors 250 may have a coupling structure in which they are respectively inserted into the opposite ends of the carbon heating element 210 through the central aperture 210a. In this case, the coil spring-shaped connectors 250 may have a diameter that allows them to be inserted and fixed to the carbon heating element 210 through the central aperture 210a.

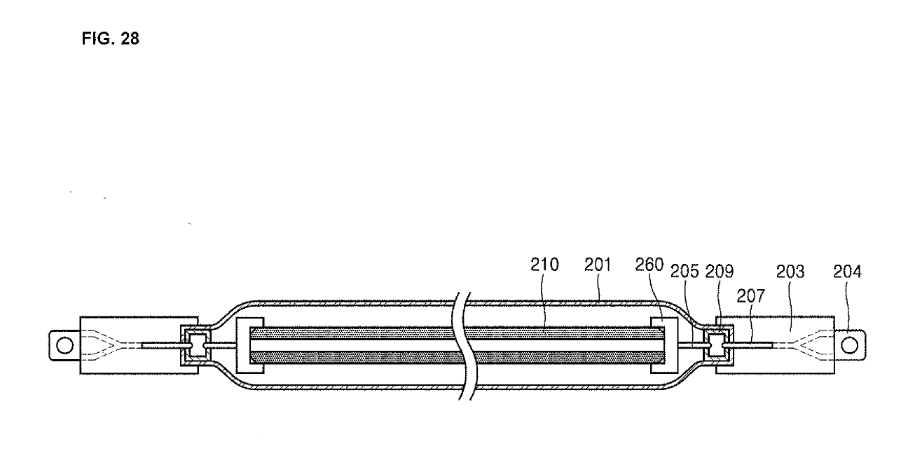

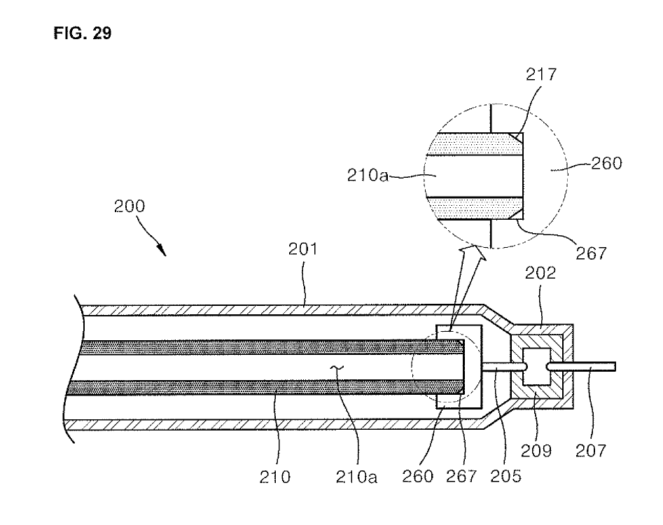

FIG. 28 shows an overall shape of carbon heater 200. FIG. 29 is an enlarged view of a coupling portion between the carbon heating element 210 and one of connectors 260 in the carbon heater 200 shown in FIG. 28.

Referring to FIGS. 28 and 29, the illustrated carbon heater 200 may include the tube 201, the carbon heating element 210, and the connectors 260. Referring to the overall shape of the carbon heater 200 shown in FIG. 28, the connectors 260 connected to the carbon heating element 210 may be electrically connected to the metal wires 205, respectively. The metal wires 205 may be electrically connected to the outer electrodes 207 through the metal pieces 209 respectively fixed to the sealing portion 202, respectively. The outer electrodes 207 may be enclosed by the outer connectors 203, respectively, and may be electrically connected to the outer terminal 204 respectively protruding outward from the outer connector 203, respectively.

Referring to FIG. 29, the tube-shaped carbon heating element 210 having the central aperture 210a may be arranged in the longitudinal direction of the tube 201 within the tube 201, and the connectors 260 may be coupled to the opposite ends of the carbon heating element 210, respectively.

As a specific example, each of the connectors 260 may provided with an insertion groove 267. The insertion groove 267 may differ from the screw groove 243 of each of the connectors 240 shown in FIG. 24 described above in that no thread is formed.

The opposite ends of the carbon heating element 210 may be inserted into the insertion grooves 267 of the connectors 260 in a fitting manner (for example, a tight fitting manner), respectively. In order for the opposite ends of the carbon heating element 210 to be more smoothly inserted into the insertion grooves 267, chamfered portions 217 processed at a predetermined inclination angle may be formed at each of the opposite ends of the carbon heating element 210.

The chamfered portions 217 may have a different shape from the illustrated shape, and may be various shapes. In addition, although not shown in the drawings, an adhesive may be applied between the respective insertion grooves 267 of the connectors 260 and the opposite respective ends of the carbon heating element 210 inserted into the insertion grooves 267. For example, when a high-temperature adhesive is applied, an interlocking strength between the respective connectors 260 and the opposite respective ends of the carbon heating element 210 may be further enhanced.

As described above, according to a configuration and a function of embodiments disclosed herein, dedicated connectors for improving durability of a bulk-shaped carbon heating element may be used, thereby improving performance of the carbon heater and increasing service life of the device. Further, the carbon heater according to embodiments uses a carbon heating element having a bulk shape, not a conventional carbon fiber, thereby preventing a dielectric breakdown, a spark and plasma, which are disadvantages of the conventional carbon fiber, from occurring. Furthermore, the carbon heater according to embodiments uses dedicated connectors which respectively support opposite ends of a bulk-shaped carbon heating element with a predetermined rigidity, thereby structurally preventing impacts applied to the carbon heating element.

The carbon heating element according to embodiments may be manufactured through the following method.

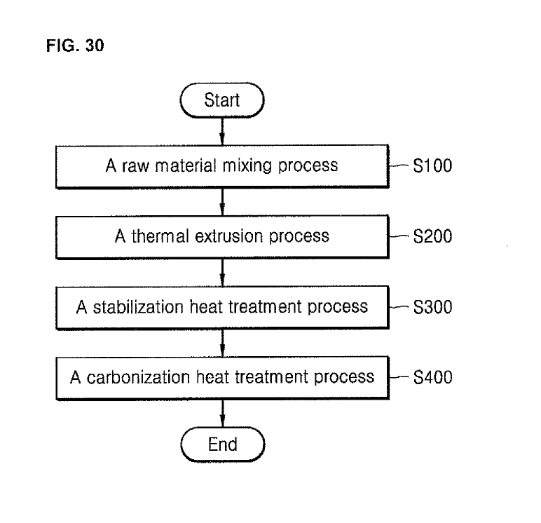

FIG. 30 shows a method for manufacturing a carbon heater according to embodiments. The method may include a process of mixing raw materials made of a carbon composite composition (hereinafter referred to as “carbon composite composition”, “composition” or “raw materials”), an extrusion process, a stabilization heat treatment process, and a carbonization heat treatment process. First, embodiments may use a carbon composite composition including a phenolic resin as a binder, a lubricant, and a base material determining a specific resistance of a resistance heating element at a high temperature, as raw materials.

The manufacturing method according to embodiments may start with a process of uniformly mixing the raw materials (S 100). In the mixing process, the raw materials each having desired components and composition ranges may be prepared, and then sufficiently mixed for a desired or predetermined time using a mill. Next, the uniformly mixed raw materials may be subjected to the extrusion process which is widely used when forming a shape in the field of a polymer resin, such as a binder (S 200).

According to the manufacturing method according to embodiments, the stabilization heat treatment process may be performed following the extrusion process (S 300). The stabilization heat treatment process aims to cure the binder such that the extruded carbon composite composition may maintain its extruded shape to assure mechanical stability.

Subsequently, the cured carbon composite composition may be subjected to the carbonization heat treatment process (S 400). The carbonization heat treatment process aims to produce an active component of the carbon heater which is a final product, and may include a first step or operation of out-gassing components which volatilize a volatile component among the components constituting the carbon composite composition, and a second step or operation of carbonizing the remaining components subsequent to the out-gassing step.

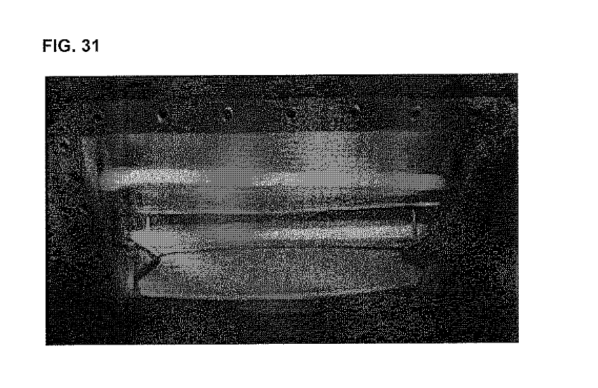

FIG. 31 shows an operation state of a carbon heater manufactured using a carbon heating element manufactured according to the manufacturing method of FIG. 30. As shown in FIG. 31, the carbon heater manufactured using the carbon heating element according to embodiments stably operates as a heater without generating sparks or plasma resulting from a dielectric breakdown in comparison to the carbon heater made of the conventional carbon fiber. Also, FIG. 31 shows that it is possible to prevent lifespan-shortening and destruction of the carbon heater by absorbing stress, impacts, or deformations from the outside through the groove capable of absorbing impact.

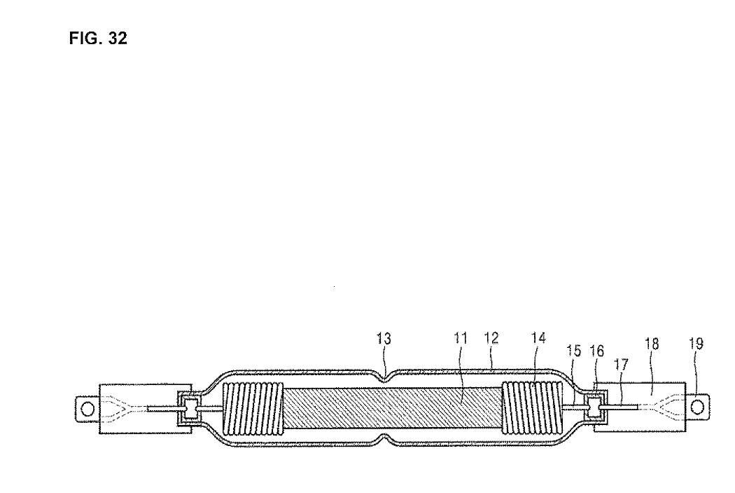

FIG. 32 shows a carbon heater product made of heating element 11 using the composition according to embodiments. The actual carbon heater may include the heating element 11 and connector 14 that supports the heating element 11 and supplies power from outside. Also, the carbon heater may include tube 12 that encloses the heating element 11 and contains inert gas, groove 13, metal wire 15 to supply electricity to the heating element 11 from the outside, metal piece 16, outer electrode 17, outer connector 18, and outer terminal 19, for example.

It should be apparent to those skilled in the art that a heater having an impact-resistant structure according to embodiments is applicable to all heaters using not only a carbon heating element but also other brittle materials (for example, a ceramic material) as a heat source. Therefore, the impact resistant structure according to embodiments is applicable not only to a heater employing a carbon heating element, but also to a heater including a carbon heating element, equivalents, and modifications thereof, for example.

Embodiments disclosed herein provide a novel carbon heater in which a dielectric breakdown, a spark, and plasma do not occur even under a high voltage. Further, embodiments disclosed herein provide a carbon heater having an impact-resistant structure for reducing impact applied to a carbon heat element which is a heat source to prevent breakage or destruction of the carbon heat element. Furthermore, in relation to constituting a carbon heater with a carbon heating element having a bulk-shape, embodiments disclosed herein provide a carbon heater having a connector used for the carbon heating element which may improve durability by preventing damage or breakage of a heat source made of the bulk-shaped carbon heating element during use.

According to embodiments disclosed herein, there may be provided a heater including a carbon heating element that functions as a heat source, a tube that encloses the heat source, and a groove portion or groove that extends from an outer peripheral portion of the tube in a direction toward a center of an interior of the tube. The heater may include an outer electrode that supplies power to the heat source from an outside, and a connector that connects the outer electrode and the heat source, The groove portion may be in contact with the heat source. Alternatively, in order to prevent a decline in radiation efficiency and energy efficiency of the carbon heater, and destruction of the tube resulting from devitrification, the groove portion may not be in contact with the heat source.

The tube may be a fused quartz tube. In particular, in order to prevent stress, impacts, or deformations from being applied to the heat source, the connector may be an elastic body.

A plurality of the groove portions may be formed opposite each other in a direction toward a center of an interior of the tube at a predetermined position in a longitudinal direction of the tube. The groove portion may be formed at a position enclosing a portion of the connector in the longitudinal direction of the tube.

The groove portion may have a shape continuously extending from a predetermined position in the longitudinal direction of the tube in a direction toward the center of the interior of the tube. Two or more groove portions may be spaced apart from each other in the longitudinal direction of the tube.

According to embodiments disclosed herein which are effective in preventing the tube from being devitrified, improving efficiency of the carbon heater, and preventing breakage of the carbon heater, the plurality of groove portions may be formed at an angle of 120 degrees or less with respect to each other in the direction toward the center of the interior of the tube from the exterior of the tube at a predetermined position in the longitudinal direction of the tube.

The carbon heater according to embodiments disclosed herein, which may improve durability by preventing damage or breakage of the carbon heating element during use, may include a tube having a sealed interior; a carbon heating element arranged in the tube, the carbon heating element being formed in a rod shape having a predetermined cross-section in a tube shape having a central aperture, or in a tube shape having a central aperture and an opening formed in at least one portion of the tube; and a pair of connectors respectively coupled to opposite ends of the carbon heating element. Each of the connectors may be provided with a screw protrusion, and each of the opposite ends of the carbon heating element may be provided with a screw groove with which the screw protrusion is respectively engaged. Also, each of the connectors may be provided with a screw groove, and each of the opposite ends of the carbon heating element may be provided with a screw protrusion to be engaged with the screw groove.

The connectors may have a coil spring shape, and be coupled to the opposite ends of the carbon heating element in an enclosing manner, respectively. Each of the connectors may be provided with an insertion groove corresponding to a cross-sectional shape of the carbon heating element; each of the opposite ends of the carbon heating element may be inserted into the insertion groove; and chamfered portions may be formed at the opposite ends of the carbon heating element, respectively.

An adhesive may be provided between the respective insertion grooves and the opposite respective ends of the carbon heating element inserted into the insertion grooves. A high-temperature adhesive may be additionally applied between the respective insertion grooves and the opposite respective ends of the carbon heating element inserted therein to improve an interlocking strength therebetween. The carbon heating element may have a circular or polygonal cross-section.

Unlike a carbon heater using a conventional carbon fiber, the heater according to embodiments disclosed herein uses a carbon heating element having a bulk shape instead of a fiber shape as a heat source, and accordingly, the carbon heater does not generate a local concentration of voltage between filaments, which is a disadvantage inherent in a carbon fiber, thereby fundamentally preventing a dielectric breakdown, a spark or plasma from occurring. The heater according to embodiments disclosed herein has an impact-resistant structure to reduce impact applied to the carbon heating element, thereby preventing breakage or destruction of the heat source made of the carbon heating element.

The heater having the impact-resistant structure according to embodiments disclosed herein may prevent devitrification of the tube enclosing the carbon heating element which is a heat source, thereby preventing a lifespan of the tube from being shortened. The heater according to embodiments disclosed herein may prevent irregular reflection resulting from the devitrification of the tube enclosing the carbon heating element from occurring not to cause a decline in radiation efficiency, thereby maintaining efficiency of the heater.

The carbon heater according to embodiments disclosed herein may use dedicated connectors which respectively support the opposite ends of the bulk-shaped carbon heating element with a predetermined rigidity, thereby structurally preventing impacts from being applied to the carbon heating element. The carbon heater according to embodiments disclosed herein may have an improved function of absorbing the impacts because, when the carbon heating element and the connectors are screw-coupled, a mutual contact area increases.

Embodiments are described with reference to illustrative drawings, but are not limited by the embodiments described herein and accompanying drawings. It should be apparent to those skilled in the art that various changes which are not exemplified herein but are still within the spirit and scope may be made. Further, it should be apparent that, although an effect from a configuration of embodiments is not clearly described in the embodiments, any effect, which can be predicted from the corresponding configuration, is also to be acknowledged.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the disclosure are described herein with reference to cross-section illustrations that are schematic illustrations of idealized embodiments (and intermediate structures) of the disclosure. As such, variations from the shapes of the illustrations as a result, for example, of manufacturing techniques and/or tolerances, are to be expected. Thus, embodiments of the disclosure should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A heater, comprising:
a carbon heating element that functions as a heat source;
a tube that encloses the heat source and having a sealed interior; and
at least one groove that extends from an outer peripheral portion of the tube in a direction toward a center of the interior of the tube.

2. The heater according to claim 1, further comprising:
an outer electrode that supplies power to the heat source from an outside;
a connector that connects the outer electrode and the heat source;
a metal piece positioned between the connector and the outer electrode;
an outer connector that encloses the outer electrode; and
an outer terminal connected to the outer connector.

3. The heater according to claim 2, wherein the connector is an elastic body.

4. The heater according to claim 2, wherein the at least one groove is formed at a position at which the tube encloses a portion of the connector in a longitudinal direction of the tube.

5. The heater according to claim 1, wherein the at least one groove is in contact with the heat source.

6. The heater according to claim 1, wherein the at least one groove is not in contact with the heat source.

7. The heater according to claim 1, wherein the tube is a fused quartz tube.

8. The heater according to claim 1, wherein the at least one groove includes a plurality of the grooves formed opposite each other in a direction toward the center of the interior of the tube at a predetermined position in a longitudinal direction of the tube.

9. The heater according to claim 1, wherein the at least one groove continuously extends from a predetermined position in a longitudinal direction of the tube in a radial direction of the tube.

10. The heater according to claim 1, wherein the at least one groove includes two or more grooves spaced apart from each other in a longitudinal direction of the tube.

11. The heater according to claim 1, wherein the at least one groove includes a plurality of grooves formed at an angle of 120 degrees or less with respect to each other in a direction toward the center of the interior of the tube from an exterior of the tube at a predetermined position in a longitudinal direction of the tube.

12. A heater, comprising:
a tube having a sealed interior;
a carbon heating element arranged in the tube, the carbon heating element being formed in a rod shape having a predetermined cross-section, in a tube shape having a central aperture, or in a tube shape having a central aperture and an opening formed in at least one portion of the tube; and
a connector coupled to each of opposite ends of the carbon heating element.

13. The heater according to claim 12, wherein the connector is provided with a screw protrusion, and each of the opposite ends of the carbon heating element is provided with a screw groove with which the screw protrusion is engaged.

14. The heater according to claim 12, wherein the connector is provided with a screw groove, and each of the opposite ends of the carbon heating element is provided with a screw protrusion to be engaged with the screw groove.

15. The heater according to claim 12, wherein the connector has a coil spring shape, and is coupled to each of the opposite ends of the carbon heating element in an enclosing manner.

16. The heater according to claim 12, wherein the connector is provided with an insertion groove corresponding to a cross-sectional shape of the carbon heating element; each of the opposite ends of the carbon heating element is inserted into the insertion groove; and a chamfered portion is formed at each of the opposite ends of the carbon heating element.

17. The heater according to claim 16, wherein an adhesive is further provided between the insertion groove and each of the opposite ends of the carbon heating element inserted into the insertion groove.

18. The heater according to claim 12, wherein an outermost cross-section of the carbon heating element is circular or polygonal.

19. The heater according to claim 12, further comprising:
an outer electrode that supplies power to the carbon heating element from an outside;
a connector that connects the outer electrode and the heat source;
a metal piece positioned between the connector and the outer electrode;
an outer connector that encloses the outer electrode; and
an outer terminal connected to the outer connector.

20. The heater according to claim 12, wherein the tube is a fused quartz tube.
